(19) United States
(12) Patent Application Publication
(10) Pub. No.: US 2017/0223560 A1
(43) Pub. Date: Aug. 3, 2017

(54) DEVICE, METHOD, OR STORAGE MEDIUM FOR WIRELESS COMMUNICATIONS

(71) Applicant: KABUSHIKI KAISHA TOSHIBA, Minato-ku (JP)

(72) Inventors: Takeshi ISHIHARA, Yokohama (JP); Tsuguhide AOKI, Kawasaki (JP); Hiroki MORI, Kawasaki (JP)

(73) Assignee: KABUSHIKI KAISHA TOSHIBA, Minato-ku (JP)

(21) Appl. No.: 15/259,653

(22) Filed: Sep. 8, 2016

(30) Foreign Application Priority Data
Jan. 29, 2016 (JP) 2016-015757

(51) Int. Cl. H04W 24/08; H04B 7/04; H04W 4/06

(52) U.S. Cl. CPC H04W 24/08; H04W 4/06; H04B 7/0452; H04W 84/12

(57) ABSTRACT

According to one embodiment, a wireless communication device includes a wireless communication unit connected to a wireless network and a controller configured to control the wireless communication unit. The controller is configured to notify the wireless communication unit of characteristics information on communications of the wireless network. The wireless communication unit is configured to simultaneously transmit signals to the Wireless network based on the characteristics information.

### CROSS-REFERENCE TO RELATED APPLICATIONS

This application is based upon and claims the benefit of priority from Japanese Patent Application No. 2016-015757, filed Jan. 29, 2016, the entire contents of which are incorporated herein by reference.

### FIELD

Embodiments described herein relate generally to a device, a method, or a storage medium for wireless communications capable of simultaneously transmitting data to respective communication partners.

### BACKGROUND

There is a multiuser multiple-input multiple-output (MU-MIMO) transmission technology for simultaneously transmitting data through a wireless network to respective communication partners. Transmission from a base station to some terminals in such wireless communications that use the above transmission technology is called a downlink multiuser multiple-input multiple-output (DL-MU-MIMO) transmission, which is adopted in the Institute of Electrical and Electronics Engineers (IEEE) 802.11ac standard.

A base station which performs DL-MU-MIMO transmissions repeats a process which comprises a step of determining which data should be simultaneously transmitted with consideration given to radio wave conditions between the base station and the respective communication partners, a step of coding the selected data, and a step of transmitting the coded data as respective radio waves.

Data, which are transmitted over the radio waves between a base station and a terminal, may change in code length whenever the radio wave environment between the base station and the terminal changes. As a result, the code length of the transmitted data and a space occupying time allotted to the code length of the transmitted data do not coincide with each other. Therefore, in order to maximize a system throughput, it is important to select data having a suitable code length for every transmitting process.

If several items of data which are different from one another in space occupying time are transmitted, there is proposed a technique for raising a system throughput, in which frames, each collectively containing those items of data that are to be transmitted to the same terminal, are prepared to make the terminals uniform in space occupying time, and the frames thus prepared are transmitted to the respective terminals.

In a DL-MU-MIMO technology, some items of data are chosen out of a lot of items of data, and are simultaneously transmitted to some terminals. Therefore, many terminals connected to a wireless communication device are divided into some groups of terminal, each comprising an arbitrary number of terminals (which is also called a group forming process or a grouping process). The order of groups is determined (the data should be transmitted to which group first, and the data should be transmitted to which group next). It is also called a scheduling process. These processes are complicated and consume large energy. The order in which a grouping process and a scheduling process are executed may be reversed.

### BRIEF DESCRIPTION OF THE DRAWINGS

FIG. 1 is a block diagram illustrating an exemplary structure of a wireless communication device according to a first embodiment.

FIG. 2 is a sequence diagram illustrating an example operation of a controller of the wireless communication device according to the first embodiment.

FIG. 3 is a sequence diagram illustrating an example operation of a wireless I/F of the wireless communication device according to the first embodiment.

FIGS. 4A, 4B, and 4C illustrate an example of the characteristics information according to the first embodiment.

FIGS. 5A and 5B illustrate an example of the characteristics information notified to the wireless I/F for every session according to the first embodiment.

FIGS. 6A and 6B illustrate an exemplary group reconstruction process according to the first embodiment.

FIG. 7 illustrates an exemplary frame transmitted to one group according to the first embodiment.

FIG. 8 is a flow chart illustrating an exemplary transmission process according to the first embodiment.

FIG. 9 is a flow chart illustrating an exemplary group reconstruction process of FIG. 8.

FIG. 10 is a block diagram illustrating an exemplary structure of a wireless communication device according to a second embodiment.

FIGS. 11A and 11B illustrate a queue for wireless transmissions according to a third embodiment.

FIGS. 12A and 12B illustrate exemplary wireless transmissions according to a fourth embodiment.

FIG. 13 is a sequence diagram of a controller of a wireless communication device according to a fifth embodiment.

FIG. 14 is a sequence diagram of a wireless I/F of the wireless communication device according to the fifth embodiment.

FIG. 15 is a sequence diagram of a controller of a wireless communication device according to a sixth embodiment.

FIG. 16 is a sequence diagram of a controller of a wireless communication device according to a seventh embodiment.

FIGS. 17A, 17B, and 17C illustrate an example operation of a wireless communication device according to a seventh embodiment.

### DETAILED DESCRIPTION

In general, according to one embodiment, a wireless communication device includes a wireless communication unit connected to a wireless network and a controller configured to control the wireless communication unit. The controller is configured to notify the wireless communication unit of characteristics information on communications of the wireless network. The wireless communication unit is configured to simultaneously transmit signals to the wireless network based on the characteristics information.

A DL-MU-MIMO technology will be explained below as a technique for simultaneously transmitting data through a wireless network to communication partners. However, it is possible to use an Orthogonal Frequency Division Multiple Access (OFDMA) technology instead of the DL-MU-MIMO technology. It should be noted here that, although what is called a wireless LAN specified as IEEE-802.11 will be explained below as a wireless communication system which makes use of a DL-MU-MIMO technology, communication modes to which every embodiment is applicable is not restricted to the wireless LAN.

### First Embodiment

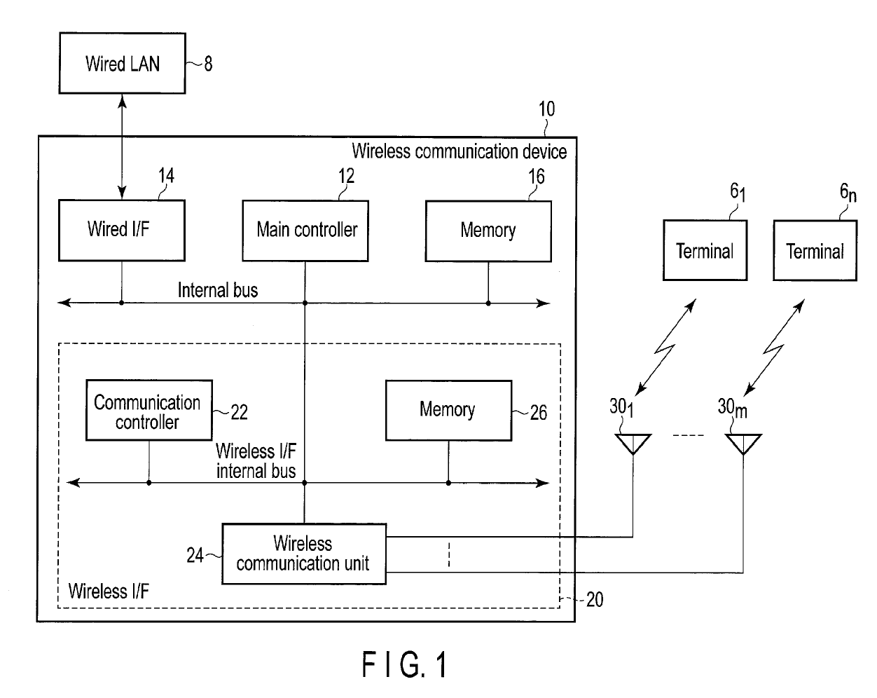

FIG. 1 is a block diagram illustrating an exemplary wireless communication device 10 according to a first embodiment. The wireless communication device 10 corresponds to a wireless base station in a wireless LAN, and is also called an access point. The wireless communication device 10 has a function to relay communications between a wired LAN 8 and wireless LAN (or each of wireless LAN terminals (which are also called terminals) 6₁-6ₙ constituting the wireless LAN).

The wireless communication device 10 includes a main controller 12, a wired I/F 14, a memory 16, and a wireless I/F 20, all connected to an internal bus. The main controller 12, which controls the whole wireless communication device 10, may be implemented by hardware or by a CPU which executes an OS and application programs that allow specific functions to be performed. The main controller 12 includes nonvolatile memories, such as NAND flash memories or the like, for storing an OS and application programs. The memory 16 is used to temporarily store data which is used by a software which the main controller 12 executes or to temporarily store data which are transferred from the wireless communication device 10 to the respective terminals 6₁-6ₙ. A volatile semiconductor memory such as SDRAM may be an example of the memory 16. The wired I/F 14 includes an interface which connects the wireless communication device 10 to the wired LAN 8. The wireless I/F 20 includes an interface which connects the wireless communication device 10 to the wireless LAN which includes the terminals 6₁-6ₙ. The terminals 6₁-6ₙ may be personal digital assistants, such as a smart phone, a tablet, and a notebook type personal computer.

The wireless I/F 20 includes a communication controller 22, a wireless communication unit 24, and a memory 26, all of which are connected to a wireless I/F internal bus. The communication controller 22, the wireless communication unit 24, and the memory 26 may be combined into a one-chip integrated circuit called a wireless LAN chip. The communication controller 22 receives from the main controller 12 a communication request and a transmission instruction, or controls the operation of the wireless I/F 20. Similarly to the main controller 12, the communication controller 22 may be implemented by hardware or a CPU which executes an OS and application programs that allow specific functions to be performed. The memory 26 is a buffer which temporarily stores data which the wireless I/F 20 transmits or receives. A volatile memory, such as SRAM and SDRAM may be some examples of the memory 26. The wireless communication unit 24 performs a process of reading from the memory 26 data, transmission of which has been instructed by the communication controller 22, changing the read data into a signal which can be transmitted as a radio wave, and transmitting the signal as the radio wave, and a process of extracting the data from the signal received as the radio wave, changing the data into a state where the communication controller 22 can refer to them, and storing them in the memory 26. In order to meet the DL-MU-MIMO technology, the wireless communication unit 24 is connected to all the antennas 30₁-30ₘ, the total number of the antennas being equal to a multiple number m. The wireless communication unit 24 transmits a known signal to each of the terminals 6₁-6ₙ. Each of the terminals 6₁-6ₙ estimates radio propagation circumstances, and feeds back an estimated result to the wireless communication unit 24. The wireless communication unit 24 makes up a transmitting beam based on the estimated result of the radio propagation circumstances fed back from the terminals 6₁-6ₙ, and performs space-division-multiple-access transmission. It is this transmission beam forming that achieves practical use of space resources.

In the above explanation, the wireless I/F 20 may be implemented as a single chip. Similarly, it is possible that each of the sections illustrated in FIG. 1 may be implemented as a single chip, or that the wireless I/F 20 may consist of separate parts. Even if the wireless I/F 20 comprises separate parts, it is still possible that the memories 16 and 26 may be combined into a single piece, and that the main controller 12 and the communication controller 22 may be combined into another single piece.

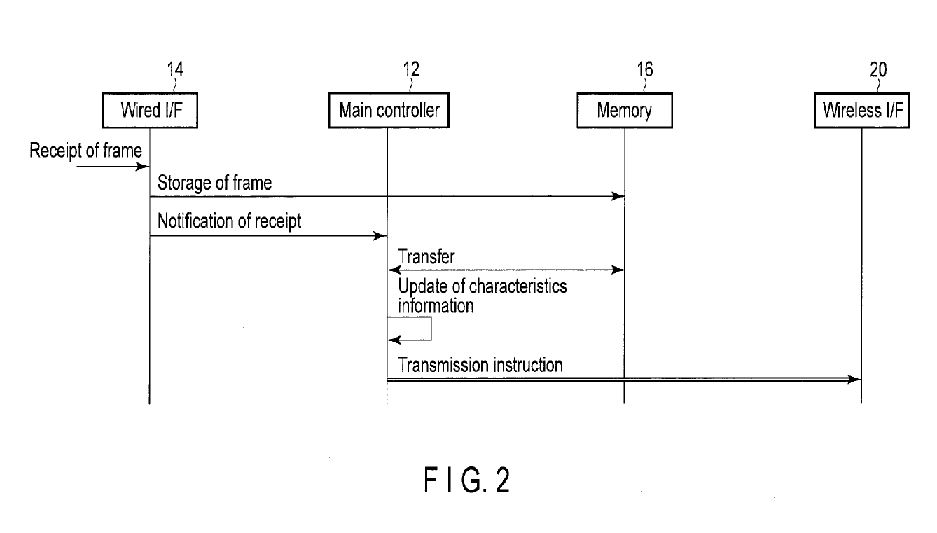

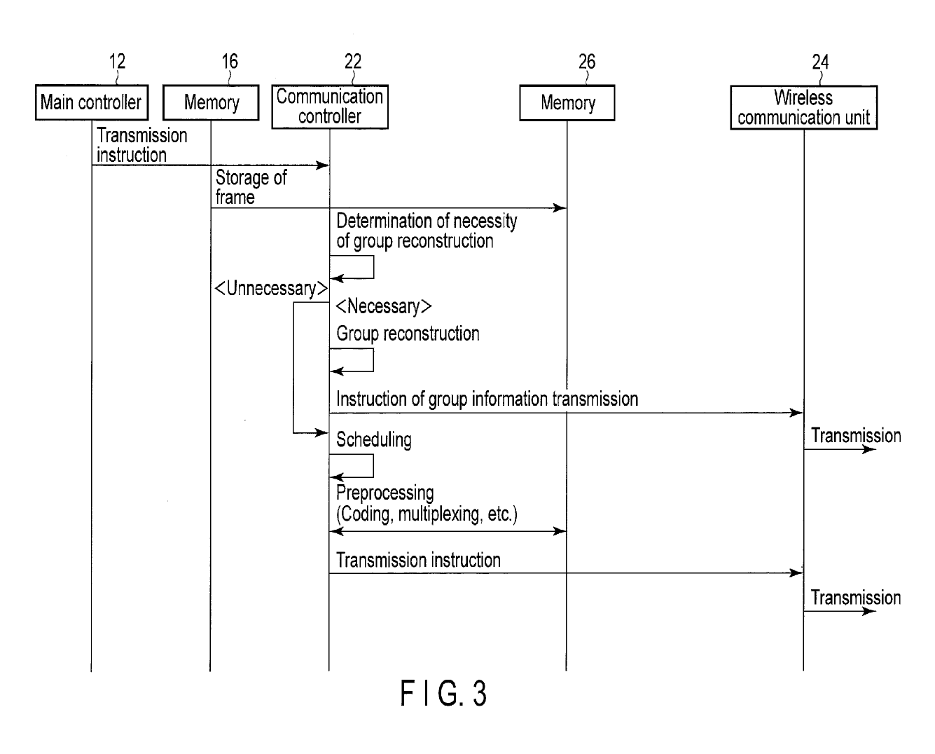

Now, an exemplary operation of the wireless communication device 10 will be explained with reference to FIG. 2 and FIG. 3. FIG. 2 is a sequence diagram illustrating how the main controller 12 of the wireless communication device 10 receives a frame from the wired LAN 8, and transfers the frame to the wireless LAN. FIG. 3 is a sequence diagram illustrating a transmission operation of the wireless I/F 20. The operation of FIG. 2 is one of the triggers which make the operation of FIG. 3 start. The operation of FIG. 3 can be executed separately from the operation of FIG. 2. The trigger which makes the operation of FIG. 3 start is not confined to the operation of FIG. 2. It is possible to make the transmission operation of FIG. 3 start by an application program which the wireless communication device 10 executes. It is certain that any wireless communication device also executes a receiving operation. However, the receiving operation has little relation to the DL-MU-MIMO technology. Therefore, explanation of the receiving operation is omitted.

As illustrated in FIG. 2, transmission in the embodiment will be started when the wired I/F 14 receives from the wired LAN 8 such data (hereafter also referred to as a frame) that should be transferred to one of the wireless LAN terminals 6. The wired I/F 14 stores the received frame in the memory 16. Then, the wired I/F 14 reports receipt of the frame to the main controller 12. The main controller 12 subjects the frame in the memory 16 to various processes necessary for transfer (determination of transfer propriety, search of a transfer table, determination of an output I/F used for transfer, conversion of a frame format between a wired transmission and a wireless transmission, etc.), and a process for updating characteristics information. Transfer propriety can be determined based on the information in a header of the frame. An output I/F is said to be different when it is different in frequency even if it is the same in wireless system. Although the details of characteristics information will be described later, characteristics information quantitatively expresses transmissions which the terminal 6 performs through the wireless communication device 10. It is characteristics information that makes it possible for the wireless I/F to improve the performance of wireless transmissions to a plurality of terminals 6. Characteristics information is stored in the memory of the main controller 12, or the memory 16.

Subsequently, the main controller 12 transmits out a transmission instruction to the wireless I/F 20, and performs radio data transmission.

The transmission instruction transmitted from the main controller 12 to the wireless I/F 20 (see FIG. 2) is interpreted by the communication controller 22 of the wireless I/F 20 as illustrated in FIG. 3. The communication controller 22 interprets the substance of the instruction, and copies a frame, which constitutes a transmission object, from the memory 16 of the wireless communication device 10 to an internal buffer or the memory 26 of the wireless I/F 20. Any method other than making a copy may be used. For instance, it is possible that the main controller 12 may directly write the frame in the memory 26.

In the DL-MU-MIMO technology, terminals to which an access point can simultaneously transmit data are determined as one group. Two or more such groups may exist. A group is determined based on characteristics information in such a manner that frames each in maximum size addressed to respective terminals may be continually supplied to a queue implemented in the memory 26 (in this case, a throughput is high). This grouping process is performed periodically. When frames constituting a transmission object have been all stored in a queue in the memory 26, it will be determined whether the communication controller 22 needs to change (or reconstruct) the group of terminals which constitutes a recipient group of simultaneous transmission.

If it is determined after the grouping process has been finished that it is necessary to reconstruct the groups because radio wave conditions have changed or a terminal included in a group has moved outside of a communication range, the communication controller 22 performs a group reconstruction process, and transmits a group information transmission instruction (indicating that which terminal belongs to which group) to the wireless communication unit 24 in order to transmit information on new groups to each of the terminals 6₁-6ₙ. If it is determined that reconstruction process is unnecessary, the process will be continued as it is.

Subsequently, the communication controller 22 makes a scheduling process to determine an order of groups to which the data should be actually transmitted. In a scheduling process, the communication controller 22 tries to maintain requested QoS (Quality of Service) and determines the order of groups to which the data are transmitted, in such a manner that a system throughput will be raised as much as possible. The communication controller 22 subjects the frames in the queue in the memory 26 to preprocessing for transmission (a coding process, a multiplexing process, etc.) after transmitting order has been determined. The wireless communication unit 24 reads at a suitable timing from the queue in the memory 26 a frame group which has finished the preprocessing, and transmits the frame group as radio waves from the antennas 30₁-30ₘ.

How the main controller 12 illustrated in FIG. 2 updates the characteristics information will be now explained. Updating of characteristics information is a process between a transfer instruction and a transmission instruction in FIG. 2. In the characteristics information update process, the frames to be transmitted are classified according to predetermined classification rules. The characteristics information about wireless transmission of a frame is grasped for every classification. Characteristics information is an index which quantitatively expresses transmission process, as mentioned above, and it contributes to an improvement in performance of wireless communications. Characteristics information is defined by the throughput, the frame interval, the average frame length, the average burst length, the jitter of a throughput or jitter of a frame interval, or a combination of any two or more of these elements, for example. The classification standard and the characteristics information are stored in the memory 16.

When a destination MAC address is used as a classification rule, throughputs, frame intervals and both for each of a group of frames which have the same destination MAC address constitute characteristics information. A throughput may be obtained by counting the number and total size of those frames that have been transmitted per unit time for every destination MAC address. Frame intervals may be obtained in the following way. Whenever a frame is received, receipt time is recorded, and the difference between the present receipt time and the immediately preceding receipt time is calculated. Throughputs and frame intervals are examples of characteristics information, and some other characteristics information may be used.

As standards of classification except for a destination MAC address, there are a source MAC address, a destination IP address, a source IP address, a destination port number, a source port number, a communication protocol, etc., for example. It is also possible to make combination of various standards into a classificatory criterion. Furthermore, it is also possible to use as classification rules upper layer information, such as specific information that appears in a data portion of the upper layer. For example, if it is a communication protocol such as an HTTP, the kinds of information which is requested (a text, an image file, a movie file, etc.) can also be used as a classificatory criterion. Moreover, it is possible to manage characteristics information after the characteristics information has been changed into discrete values to have suitable granularity.

Instead of dynamically grasping characteristics information whenever one frame is transmitted, it is possible that a portion which an object frame has and corresponds to the classification rules may be compared with each and every item of previous characteristics information previously stored in the memory 16, and that an item of the previous characteristics information that agrees with the portion of the object frame may be used as characteristics information. In such a case, it is possible that the item of the previous characteristics information may be corrected using the characteristics information dynamically grasped by the aforementioned way. It is possible that the previous characteristics information is somehow added, deleted or updated through communications different from communications which transmit the characteristics information. This can be applied to a case where there is an apparatus which centrally controls a network and the apparatus does control the wireless communication device 10. In other words, it is applicable to a network architecture in which a control plane and a data plane are separated from each other.

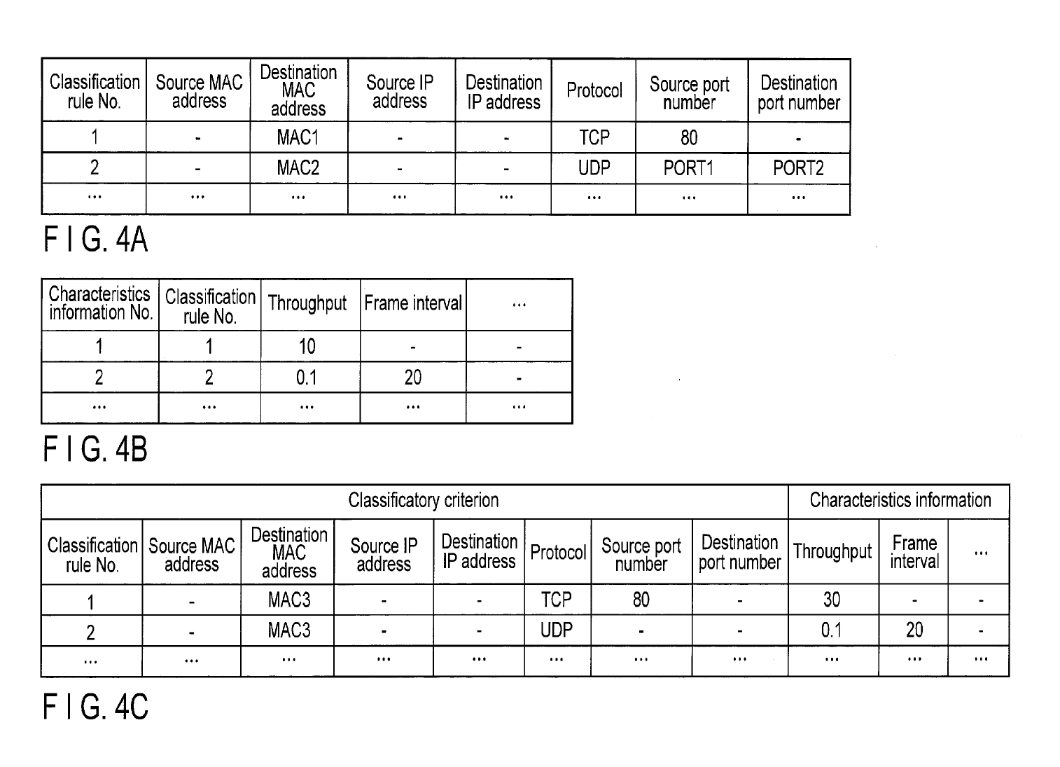

FIG. 4A illustrates classification rules, FIG. 4B illustrates characteristics information, and FIG. 4C illustrates exemplary previous characteristics information.

It should be noted that FIG. 4A illustrates various items of information using a table format, but other implementation formats may be used according to the actual circumstances. FIG. 4A illustrates two entries as exemplary classificatory criteria. A first entry listed as a classificatory criterion No. 1 specifies TCP communications, in which a number given to a source port addressed to a terminal which has a MAC address specified by “MAC1” is “80.” The second entry listed as a classificatory criterion No. 2 specifies UDP communications, in which a number given to a source port addressed to a terminal which has a MAC address specified by “MAC2” is “PORT1” and a destination port is “PORT2.” As illustrated in FIG. 4A, it is not necessary to use all the parameters as a classificatory criterion. In FIG. 4A, “-” indicates an unassigned parameter.

FIG. 4B illustrates how detected items of characteristics information are managed. Entries in a column named Classificatory Criterion No. are the same as the entries in the column named Classificatory Criterion No. illustrated in FIG. 4A. For example, a first entry in the column named characteristics information No. is an item of characteristics information that matches the entry named classificatory criterion No. 1 illustrated in FIG. 4A. An item of information that is not acquired is indicated as “-” in the same way as FIG. 4A.

FIG. 4C illustrates exemplary previous characteristics information, and comprises a left-hand side column portion indicative of classificatory criteria and a right-hand side column portion indicative of characteristics information on a communication which is in agreement with the classificatory criterion.

A transmission instruction which is indicated in the sequence diagram of the present embodiment illustrated in FIG. 2 or FIG. 3 and should be transmitted to the wireless I/F 20 from the main controller 12 will now be explained. Generally, a transmission instruction roughly includes two items of information, an instruction information, which instructs transmission, and frame data, which should be transmitted.

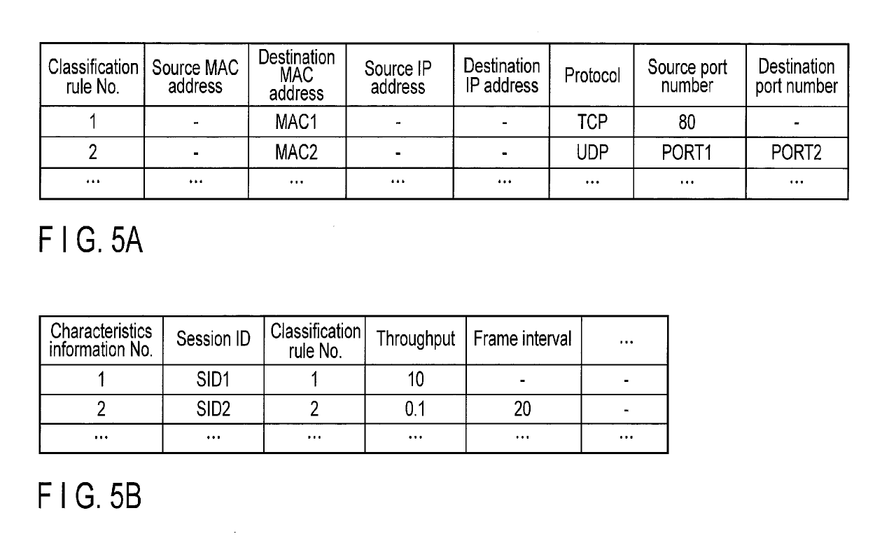

The transmission instruction of the present embodiment includes characteristics information in addition to these items of information. There are two methods, each allowing addition of characteristics information to a transmission instruction. A first method is a method which directly adds characteristics information to a transmission instruction, and can be implemented by adding a field to a message instructing transmission. The second method is a method of notifying characteristics information in a certain session unit. If the main controller 12 determines that the conditions determined in advance are satisfied, the main controller 12 exchanges session information with the wireless I/F 20, and notifies the wireless I/F 20 of characteristics information. The condition may include a case where an entry which is in agreement with the classificatory criterion of FIG. 4A and the characteristics information of FIG. 4B, each being illustrated as an exemplary condition, may not exist in the memory 16. The main controller 12 notifies the wireless I/F 20 of a classificatory criterion previously described as information for specifying a session. The wireless I/F 20 returns to the main controller 12 an identifier which has a certain form, such as a session ID, and makes it easy to identify a session. The main controller 12 adds the notified identifier to the transmission instruction, and instructs transmission. As illustrated in FIG. 5B, the memory 16 manages characteristics information, in which session IDs are included. FIG. 5A is the same as FIG. 4A.

If characteristics information is notified by the second method, it is possible to suitably update characteristics information while the session is maintained. In such a case, the main controller 12 notifies the wireless I/F 20 of a session ID and new characteristics information. It should be noted that the session which is notified to the wireless I/F 20 is canceled when predetermined conditions are satisfied. Specifically, it is canceled when a predetermined time has passed after a session ID has been issued, or when a predetermined time has passed after the last transmission instruction has been issued, or when deletion of characteristics information is explicitly instructed from the main controller 12.

A group reconstruction process (including a group construction process firstly forming a group) which the communication controller 22 executes as illustrated in FIG. 3 will be explained. The communication controller 22 gives consideration to the circumstances in which the wireless communications are performed between the communication controller 22 and each and every terminal, classifies based on characteristics information those terminals that are similar to each other in characteristics into a destination terminal group of simultaneous transmission, which becomes a MIMO group.

Similarity in characteristics includes determining that it is highly possible that a plurality of frames belonging to each of the communications compared with one another will be transmitted at a close timing or under the same QoS requirements, or determining that time occupied by a plurality of frames to transmit predetermined information (time to transmit radio waves) are close to one another. For example, if characteristics information is a throughput, it is highly possible that frames will be transmitted at almost the same timings to a terminal whose throughput falls within a predetermined range.

A criterion for determining similarity among throughputs may change when consideration is given to a radio environment. For example, suppose that there are two terminals and that the first terminal is twice the second terminal in throughput. Even in such a case, if the first terminal is twice the second terminal in link rate, time to be needed in order to transmit a frame will be the same between both the terminals. Therefore, it is possible to classify both terminals into the same group, and to simultaneously transmit those frames that are addressed to the respective terminals.

The detailed procedure of a group construction process and reconstruction process will be illustrated below. First, candidate groups of terminals are determined in a classificatory criterion based on the similarity of radio wave condition. Subsequently, the candidate groups are narrowed down, referring to the notified characteristics information. The candidate groups are classified into several groups based on the characteristic parameter indicative of a radio wave condition, for example, a link rate. A group which may achieve efficient transmission is selected out of the classified groups in the classificatory criterion. After all the candidate groups in the classificatory criterion have been examined, candidate groups in the next classificatory criterion will be subjected to the same process. It should be noted that there may finally remain some terminals that do not belong to any group. In such a case, a classificatory criterion established based on a radio wave condition is made less strict in order to prevent terminals from remaining. For example, terminals that fall within a much wider range of link rates may be classified into the same group. Nevertheless, if there remain some terminals that are not classified into any groups, they execute their transmission without using a DL-MU-MIMO technology. A group construction process proceeds in this way.

The notification of characteristics information may be performed for every transmission instruction of a frame, or it may be carried out in the unit of session as described previously. However, a group construction process and a group reconstruction process are performed whenever a predetermined time has passed or whenever a predetermined quantity of frames is transmitted. In that event, it is first determined whether reconstruction process is required or not. When it is determined that reconstruction process is required, reconstruction process will be performed.

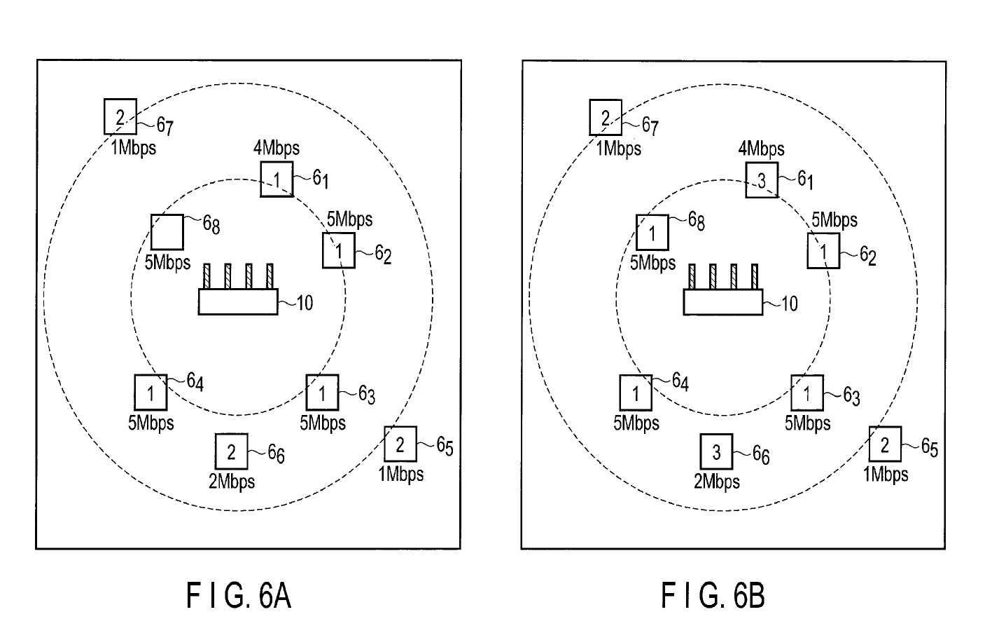

FIGS. 6A and 6B illustrate an exemplary group construction process or an exemplary group reconstruction process. What is illustrated here is an example which applies the present embodiment to a spatial multiplexing in the DL-MU-MIMO technology. As illustrated in FIG. 6A, seven terminals 6₁-6₇ are connected to the wireless communication device 10 which operates as an access point corresponding to four stream multiplexing. It is assumed that characteristics information is a throughput. Terminals 6₁-6₇ have their respective assigned group numbers, which are separately illustrated in the respective square boxes in the drawing. It is assumed that each of the terminals 6₁-6₇ supports the DL-MU-MIMO technology and performs a one stream communication. The wireless communication device 10 and the terminals 6₁-6₇ form a group as illustrated in FIG. 6A in accordance with the procedure of the present embodiment. In particular, the terminals 6₁-6₄ form a group 1, and the terminals 6₅-6₇ form a group 2.

Let us consider a case where a new terminal 6₈ is additionally connected to the wireless communication device 10 in this situation. The terminal 6₈ will start a communication after the terminal 6₈ has finished associating with the wireless communication device 10. This communication allows the wireless communication device 10 to grasp the characteristics information on the wireless communications with the terminal 6₈. As a result, the wireless communication device 10 determines that reconstruction process of the group is needed.

The wireless communication device 10 refers to the characteristics information and the information concerning communication environment on each terminal including the terminal 6₈, confirms the radio wave condition for implementing the DL-MU-MIMO technology (whether or not spatially separate from one another, or whether the number of streams is suitable), and collects into the same group the terminals similar to one another in characteristics information. When a new group is established, the wireless communication device 10 will notify each terminal of the information on the newly established group.

In the example of FIG. 6B, there are five terminals (terminals 6₁-6₄ and 6₈) that are nearly equal to one another in distance to the wireless communication device 10 (that can be determined to be similar to one another in radio wave condition). These are determined to be a candidate group. It is assumed that the wireless communication device 10 supports multiplexing of four streams. Therefore, every group must comprise a maximum of four terminals. Hence, a combination of four terminals is selected from the five terminals. If a combination is uniquely selected in this stage, the combination can be used without confirming the characteristics information. However, there are five different combinations in the example of FIG. 6B. Therefore, the priority is attached to each combination based on the characteristics information. Among the five different combinations, a combination comprising the terminals 6₂-6₄ and 6₈ has the highest degree of similarity in characteristics information (they are equal to one another in throughput, which is 5 Mbps). Therefore, the combination of the terminals 6₂-6₄, and 6₈ will be the highest in degree of priority. As illustrated in FIG. 6B, this combination is used as a group 1.

Subsequently, a remaining candidate group including remaining terminals 65-67 which are similar to one another in radio wave condition is checked. Since the number of terminals in the group is three, the terminals 65-67 can be classified into a group. However, the terminals 65 and 67 are classified into group 2 in accordance with characteristic information (they are equal to one another in throughput, which is 1 Mbps).

As a result of forming a group in accordance with two radio wave conditions, the terminal 6₁ and the terminal 6₆ remain as unsettled terminals belonging to neither of the groups. Here, the wireless communication device 10 eases requirements for classifying terminals based on radio wave conditions, and continues forming groups. Hence, the terminal 6₁ and the terminal 6₆ are treated as the same in radio environment, and are considered in a candidate group. Subsequently, the terminal 6₁ and the terminal 6₆ are compared with each other in characteristics information to determine whether they are so similar to each other as to be classified into the same group. It is determined whether the wireless communication device 10 can communicate with the terminal 6₁ at the same time as the wireless communication device 10 communicates with the terminal 6₆ by 2 Mbps. When the terminal 6₆ is assumed to be ½ of the terminal 6₁ in link rate, a throughput which the terminal 6₁ obtains will be 4 Mbps in accordance with a difference in link rate. This satisfies the characteristics information on the terminal 6₁. Accordingly, the terminals 6₁ and 6₆ are classified into the same group, resulting in a production of group 3 which comprises the terminals 6₁ and 6₆.

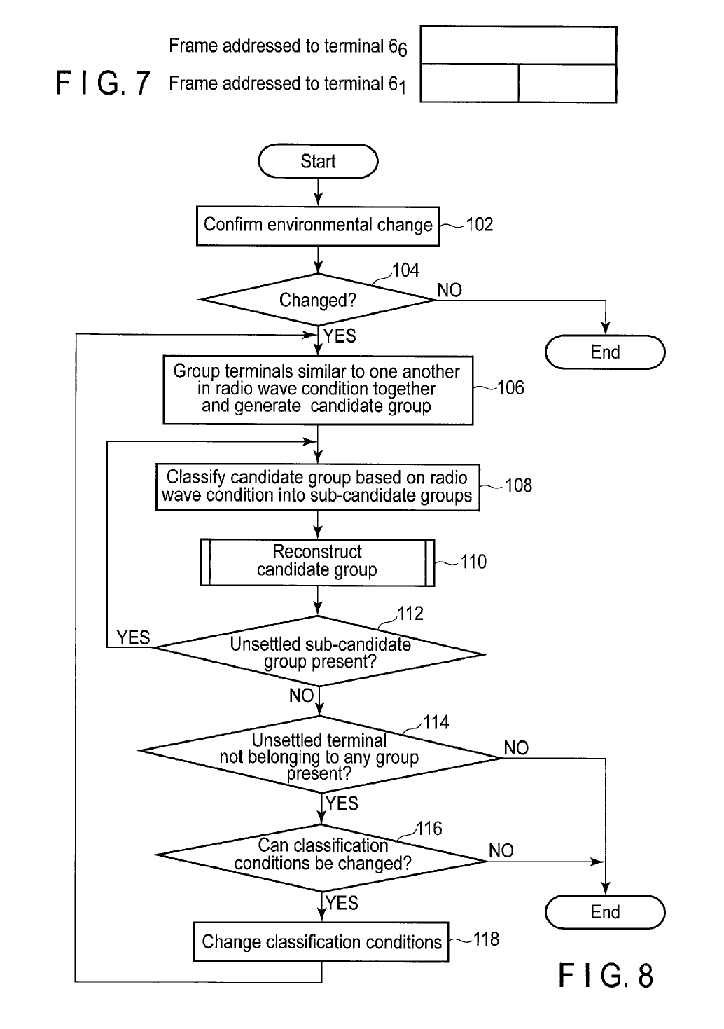

As a result of having made the terminals 6₁ and 6₆ into group 3, frames transmitted to the two respective terminals are individually constituted as illustrated in FIG. 7. For example, the number of frames transmitted to the terminal 6₁ is twice the number of frames transmitted to the terminal 6₆. Therefore, a receiving process of the terminal 6₁ is highly bursty. When frame intervals are included in the characteristics information, the receiving process can be kept low in burstiness. The terminal 6₅ and the terminal 6₇ are found finally remained, and are classified into group 2 as illustrated in FIG. 6B.

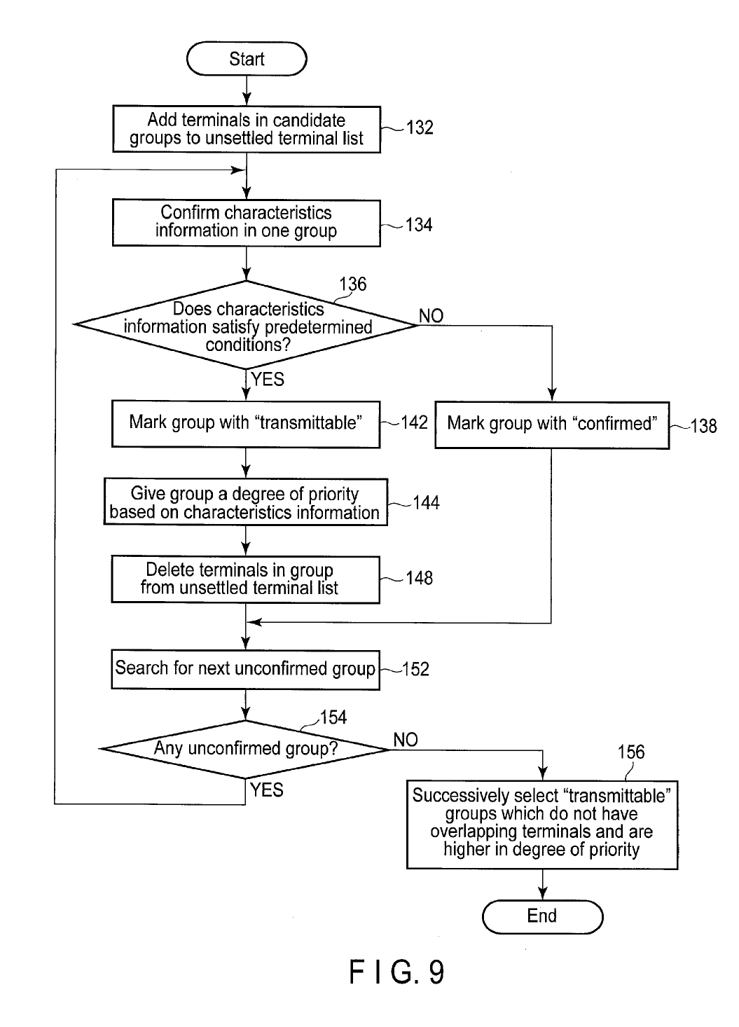

The concept obtained from the above explanation will be explained with reference to the flow charts illustrated in FIG. 8 and FIG. 9. FIG. 8 illustrates an exemplary flow of a process executed by the communication controller 22 of the wireless communication device 10. At the beginning, the communication controller 22 confirms change of a radio wave condition at block 102, and determines whether the radio wave condition changes at block 104. If the radio wave condition does not change, the process ends. If the radio wave condition changes, the communication controller 22 groups together a plurality of terminals which are similar to one another in radio wave condition to make candidate groups at block 106.

The communication controller 22 classifies terminals in the candidate group into sub-candidate groups at block 108 in accordance with characteristic parameters, each indicative of a radio wave condition (for example, link rate), and determines at block 110 which sub-candidate group can establish efficient wireless communications among the sub-candidate groups (to construct a combination of terminals). The details of block 110 are illustrated in FIG. 9.

The communication controller 22 determines at block 112 whether there is any unsettled sub-candidate group. If there is an unsettled sub-candidate group, the process returns to blocks 108 and 110. A next sub-candidate group is checked. When the process about all the sub-candidate groups is completed, the communication controller 22 determines at block 114 whether there is any unsettled terminal which does not belong to any group. If there is no unsettled terminal, the process ends. If there is an unsettled terminal, the communication controller 22 determines at block 116 whether classification rules can be changed. Change of classification conditions is making classification conditions loose so that more terminals may belong to any one of the groups. If change of classification conditions is not possible, the process ends. If change of classification conditions is possible, the communication controller 22 changes classification conditions at block 118, and executes the process from block 106 again.

The process of combining terminals (block 110) will be explained with reference to FIG. 9. At block 132, the communication controller 22 adds to an unsettled terminal list those terminals that are included in a candidate group. The communication controller 22 confirms at block 134 the characteristics information on one group, and confirms at block 136 whether the characteristics information satisfies a predetermined classification rule. If the characteristics information satisfies the predetermined conditions, the communication controller 22 marks the group with “transmittable” at block 142. If the characteristics information does not satisfy the predetermined conditions, the communication controller 22 marks the group with “confirmed” at block 138, and advances the process to block 152.

At block 144 following block 142, the communication controller 22 gives the group a priority based on the similarity which the terminals in the group has in the characteristics information. At block 148, the communication controller 22 deletes terminals included in the group from the unsettled terminal list.

The communication controller 22 searches for the next unconfirmed group at block 152, and determines at block 154 whether there is any unconfirmed group. If there is an unconfirmed group, it returns to the process of block 134. If there is not an unconfirmed group, the communication controller 22 successively selects groups at block 156 from the groups marked with “transmittable” in the order of groups which do not have any overlapping terminals and are higher in degree of priority.

### Modification of First Embodiment

There may arise a case where the characteristics information supplied from the main controller 12 to the wireless I/F 20 is largely different from the characteristics of the radio channel between the wireless communication device 10 and the terminal 6. For example, if throughputs are used as characteristics information, it may be considered that there arises a circumstance where the link rate of a radio channel is 100 Mbps or more even though the notified throughput is 1 Mbps. In such a case, the number of quota streams of MU-MIMO may be reduced while executing grouping process, reconstruction process, or scheduling process. Conversely, the number of assigned streams can be increased if supported by terminals.

A case where the classification using characteristics information is applied to the classification of DL-MU-MIMO has been explained as an embodiment. However, the embodiment is not restricted to the DL-MU-MIMO technology, but can be applied to other multiplexing schemes which may simultaneously communicate to a plurality of terminals. Specifically, the embodiment may also be applicable to a group assignment of terminals which hold OFDMA carriers in common. In OFDMA, the number of subcarriers can also be changed according to characteristics information similarly to the above modification.

It should be noted that, if an MU-MIMO technology and an OFDMA technology are simultaneously used, the embodiment is applicable to a group determination process of each technology.

### Summary of First Embodiment

As mentioned above, according to the first embodiment, the characteristics information on communications which a terminal of a transmission destination performs is sent from the main controller 12 to the wireless I/F 20. The wireless I/F 20 forms a terminal group which constitutes a simultaneous transmission destination based on the characteristics information. This achieves formation of a suitable group which simultaneously transmits frames to improve a communication efficiency, and reduces the load of grouping process imposed upon the wireless I/F 20. Moreover, terminals which are highly possible to simultaneously execute a transmission process can be grouped together. Therefore, circumstances where transmission frames run short will be suppressed. Improvement in system throughput will be expected.

Hereafter, other embodiments will be explained. In the following explanation, those portions that are the same as those of the first embodiment are attached with the same reference numbers and their detailed explanation will be omitted.

### Second Embodiment

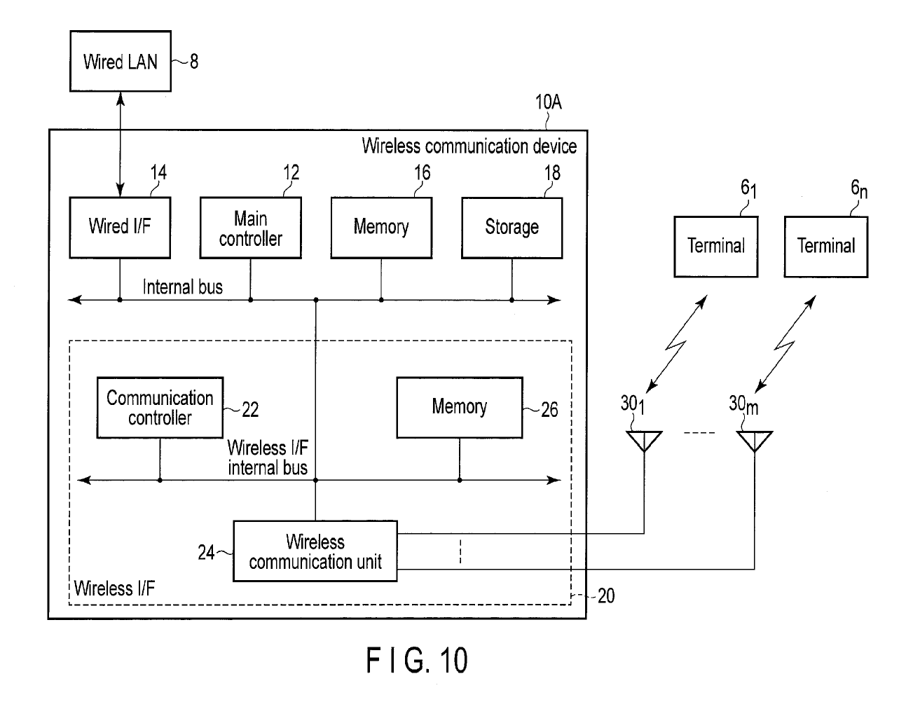

FIG. 10 is a block diagram illustrating an exemplary wireless communication device 10A according to a second embodiment. Unlike the wireless communication device 10 according to the first embodiment indicated in FIG. 1, it has a large-scale storage 18. The storage 18 comprises SSD, HDD, or the like, and can preserve much more data than the memory 16.

The wireless communication device 10A according to the second embodiment can store in the storage 18 data to be transmitted to the terminal 6, and can read the data from the storage 18 to transmit the data to a user according to a data transmission request from the terminal 6. Furthermore, the stored data may be original data, or may be the data (duplication data) received from the wired LAN 8. The main controller 12 of the wireless communication device 10A may directly receive a data transmission request from the terminal 6, or may forcibly receive a data transmission request from the terminal 6 by intercepting a communication which goes to another server. In the latter case, the wireless communication device 10A will operate as what is called an intercepted type proxy.

The wireless communication device 10A according to the second embodiment is the same in basic operation as the wireless communication device 10 according to the first embodiment. However, there are two different points. A first point is that a source (origin) of data to be transmitted may be included in the characteristics information which the main controller 12 transmits to the wireless I/F 20. Specifically, it is possible to determine whether a transmission instruction of FIG. 2 or FIG. 3 is an instruction of transmission frames to transmit data stored in the storage 18 (a local is identified as a source), or an instruction of transmission frames received from a communication partner through wired LAN 8 (a network is identified as a source). The second point is a process which the wireless I/F 20 executes based on the notified identification. The second embodiment is the same as the first embodiment in classification rules. Those terminals that are similar to one another in notified characteristics are grouped together. The second embodiment is different from the first embodiment in that the source of the transmitted data is also considered when determining similarity.

Generally, throughputs and frame receiving intervals at the time of transmitting or receiving information through a network will fluctuate because of various factors. Therefore, the wireless communication device 10A absorbs these fluctuations by buffering the transmission data in a queue in the memory 26. The same applies to a wireless LAN access point. In the case of an embodiment which executes simultaneous transmission to a plurality of terminals using a DL-MU-MIMO technology or an OFDMA technology, the fluctuation affects the operation and system throughput of a transmission process.

As described in the first embodiment, when using a DL-MU-MIMO technology, it is necessary to determine a simultaneous transmission group in advance. However, a circumstance where frames which constitute a transmission object have not reached the wireless communication device 10A because of network fluctuation may occur. As a result, a bad influence may arise such that priority may be given to the transmission of another group or a wait for a moment when frames reach a queue may occur. The same applies to a case where multiplexing is executed using an OFDMA technology.

On the other hand, since a circumstance where frames constituting a transmission object have not reached the wireless communication device will never occur in the second embodiment when data is transmitted from the storage 18 inside of the wireless communication device 10A, there is no need to wait for a moment when information can be transmitted, and there is very little possibility that communications are affected by a bad influence. That is, when transmitting data from the internal storage 18, it can be said that there is a high possibility that frames are steadily generated and stably transmitted. The information on the source of transmission data is used for determination of grouping process in the second embodiment. Therefore, terminals that are highly possible to execute a stable transmission process can be made into the same group. As a result, it is highly possible that communications will be performed as expected when determining a group in advance. The load required to schedule each time frames are transmitted will be suppressed. Moreover, it is highly possible that transmission data is supplied at a suitable timing required for transmission. It does not need to wait until it will be in a state where information can be transmitted. The fall of a system throughput can also be avoided.

Each of the local and the network has been described as a source of transmission data. However, the source is not necessarily restricted to these two. For example, a network may be subdivided into the same LAN's, an intranet, and the Internet. It becomes further difficult to be affected by the influence of fluctuation when groups are made based on finely defined source information.

The second embodiment uses the source of information to express the transmission process from the storage 18, but the same is possible if the jitter of a throughput/a frame interval is used instead of a source and similarity is expressed by the level of the jitter. A jitter is generally large at the time of transmission of the data from a network.

### Summary of Second Embodiment

In the second embodiment, the source of data transmitted to the terminal 6 is added to the characteristics information of which the main controller 12 notifies the wireless I/F 20, as mentioned above, so that the wireless I/F 20 constructs or reconstructs groups with consideration given to the source of data. Accordingly, groups to which frames are simultaneously transmit can be appropriately formed so that a communication efficiency will be further improved in comparison with the first embodiment and a load of grouping process imposed on the wireless I/F 20 will be further reduced. Moreover, terminals to which frames are highly possible to simultaneously transmit can be grouped together. The circumstances which run short of transmission frames can be suppressed. The further improvement in system throughput will be expected.

### Third Embodiment

The first embodiment or the second embodiment illustrates a method of reducing a load imposed on the wireless I/F 20 upon simultaneously transmitting information as in the case of an MU-MIMO technology or an OFDMA technology by classifying terminals into groups based on characteristics information. In the third embodiment, the communication controller 22 schedules using characteristics information. The structure illustrated in FIG. 1 or FIG. 10 may be applicable to the wireless communication device 10 of the third embodiment.

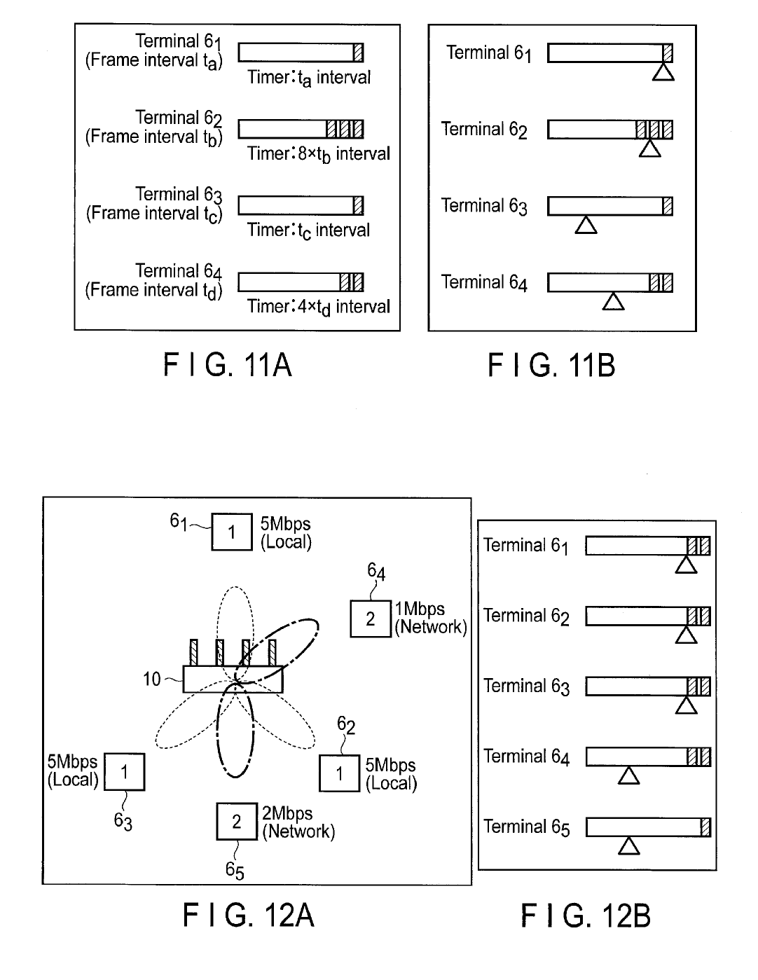

FIGS. 11A and 11B schematically illustrate a queue installed in the memory 26. The transmission from a queue is managed by a scheduler using the notified characteristics information. The scheduler is installed in the communication controller 24, for example. For example, if the characteristics information comprises a frame interval, as illustrated in FIG. 11A, a timer is managed so that a scheduler may be executed in the same timing as the interval, or the timing of the integral multiple of the interval. In FIG. 11A, four terminals 6₁-6₄ are managed, for example, and they execute their respective transmission processes at different timer intervals. The terminal 6₂ and the terminal 6₄ are set to execute their respective transmitting processes at an integral multiple of a frame interval. It is because performance will fall when a transmission process is frequently executed at frame intervals in the case of a communication which is short in frame intervals and is high in throughput. Under the present circumstances, further improvement in performance may be expected by performing aggregation of a plurality of transmission frames.

FIG. 11A illustrates a case where timers are provided for respective queues. In the event that the number of timers is restricted, terminals which are similar to one another in characteristics information (for example, frame intervals) may be managed by a single timer.

As illustrated in FIG. 11B, it is possible to set threshold values on the respective lengths which queues have, and to cause each scheduler to operate when a corresponding queue length reaches its threshold value. A threshold value may be calculated from a throughput or a frame interval notified as characteristics information. For example, if throughputs are high or frame intervals are short, the threshold values may be increased and frame aggregations may be promoted, and finally schedulers will be executed. On the contrary, if throughputs are low or frame intervals are large, schedulers may be executed without waiting for next frames. In FIG. 11B, triangles indicate threshold values. Each threshold value decreases toward the right-hand side of the drawing.

Moreover, if information on frame sources can be used as characteristics information as in the second embodiment, it is possible to set timers and threshold values using the information. In the case of a local source, there is no need to store in queue information on the local source, so that a timer can be set short and a threshold value can be set small. In the case of a network source, a timer can be set long and a threshold value can be set large to the contrary. Furthermore, a plurality of set values may be provided in combination with a source and characteristics having been explained in the first embodiment, such as a throughput and a frame interval. For example, different values may be set to combinations of throughput levels and sources (a high throughput/a local, a high throughput/a network, a low throughput/a local, a low throughput/a network). In any case, it is possible to take into consideration the wireless environment between the wireless communication device 10 and the terminal 6. It is because, even if data sizes are the same, a transmission time will change with codes which can be used according to wireless environment and the amount of frames which should be stored in queue will change.

Furthermore, the method of setting these timers and threshold values depends on the forms of practical use of the network using the wireless communication device 10. Therefore, characteristics information and a set value cannot be uniquely determined.

### Summary of Third Embodiment

As mentioned above, in the third embodiment, the main controller 12 notifies the wireless I/F 20 of characteristics information. The wireless I/F 20 uses the characteristics information for a transmission scheduling process. Accordingly, the scheduler can perform a transmission process in an order from a queue in which frames are easily accumulated. A possibility that a transmission process will be executed in a situation where there is no frame which should transmit will decrease. A useless process will decrease. A process of the communication controller 22 becomes efficient.

### Fourth Embodiment

As has been described with regard to the first to the third embodiments, a simultaneous transmission grouping process hardly causing reduction in system throughput can be made by causing the main controller 12 to notify the wireless I/F 20 of characteristic information. However, it may happen that frames, which are objects of transmission, cannot be prepared because of an influence of large variations in a communication environment. A case where a transmission process execution timing having been described with regard to the third embodiment is added to a simultaneous transmission group having been described with regard to the first or the second embodiment will be explained as a fourth embodiment. The fourth embodiment is the same in structure as the embodiment illustrated in FIG. 1 or FIG. 10.

As illustrated in FIG. 12A, five terminals 6₁-6₅ are connected to the wireless communication device 10. Let us suppose that the wireless communication device 10 grasps the characteristics information of every communication executed by any of the terminals 6₁-6₅ and that the terminals 6₁-6₅ are classified in the same way as the first or the second embodiment. Namely, terminals 6₁-6₃ are classified into group 1, and terminals 6₄ and 6₅ into group 2. In this situation, a transmission scheduling process which gives consideration to easiness in accumulation of transmission frames in each group is not implemented. For example, when a scheduling process is made with the use of a simple round-robin system, it may happen that a transmission process is executed at a timing in which transmission frames are not yet prepared.

A mechanism which controls a transmission process execution timing as has been described with regard to the third embodiment is added to the above system. Namely, after terminals have been classified into groups, threshold values are set for queue lengths of transmission queues assigned for the terminals in the group. When all these queue lengths satisfy the threshold values, a transmission process will be executed. Frames transmitted to terminals 6₁-6₃ of group 1 are data read from the storage 18 in the wireless communication device 10. Therefore, transmitting process can be performed smoothly. Thus, a small threshold value is set, as illustrated in FIG. 12B. Triangles illustrated in FIG. 12B individually indicate a threshold value. Each threshold value decreases toward the right-hand side of the drawing. On the other hand, terminals 6₄-6₅ in group 2 transmit frames which they have received through the network. Therefore, they each require a large threshold value to be set so that they can be scheduled to perform a transmission process to the wireless network in a condition that as many frames as possible are accumulated. How to control the scheduling process is not restricted to the threshold values, but an adjustment of setting time of a timer may be used, as has been described with regard to the third embodiment.

### Summary of Fourth Embodiment

As mentioned above, the wireless I/F 20 in the fourth embodiment forms a group, which can perform simultaneous transmission, based on the characteristics information, and controls the scheduling of a transmission process according to the characteristics information. This makes it possible to suppress generation of a transmission process for a group which lacks transmittable frames, resulting in suppression of decrease in system throughput. Moreover, a possibility that information runs short becomes small, which eliminates an excessive process from occurring. The communication controller 22 will be improved in efficiency of operation.

### Fifth Embodiment

In the embodiments mentioned above, the main controller 12 of the wireless communication device 10 notifies the communication controller 22 of the wireless I/F 20 of the characteristics information which indicates the feature of wireless communications. The fifth embodiment implements a function that the wireless I/F 20 notifies the main controller 12 of the circumstances of wireless communications.

The structure of the fifth embodiment is the same as that illustrated in FIG. 1 or FIG. 10. However, the fifth embodiment needs a buffer for frames. Therefore, in the case of FIG. 1 which does not have the storage 18, some mechanism which allows the memory 16 to accumulate frames is needed. In the case of FIG. 10, which does have the storage 18, what is necessary is just to use a part of the storage 18 as a buffer for frames.

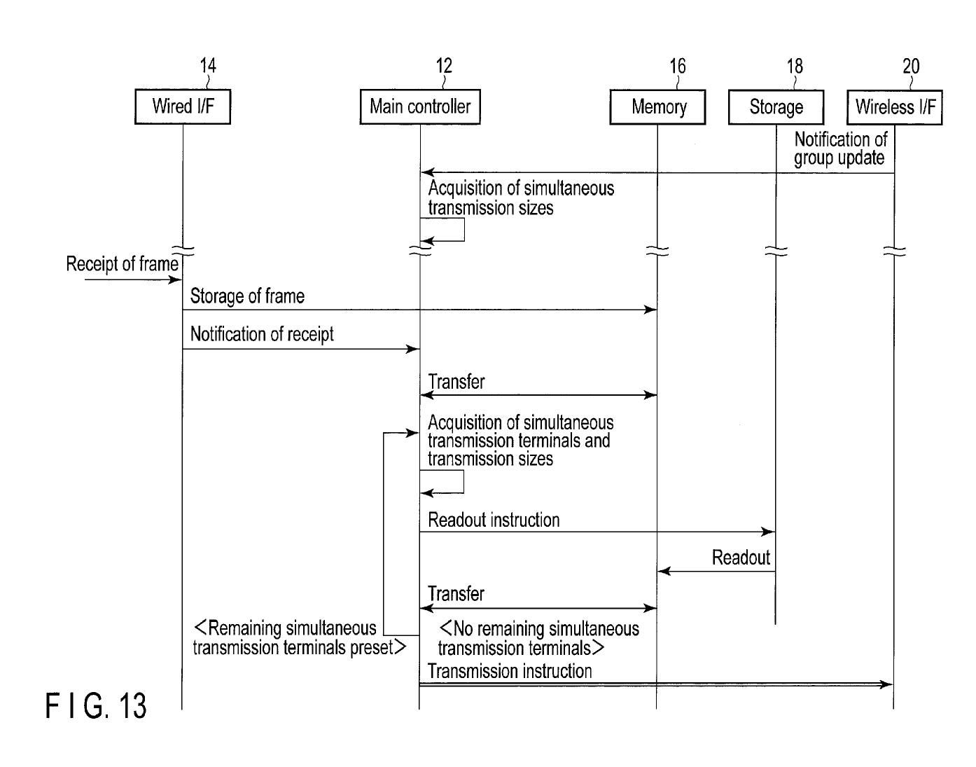

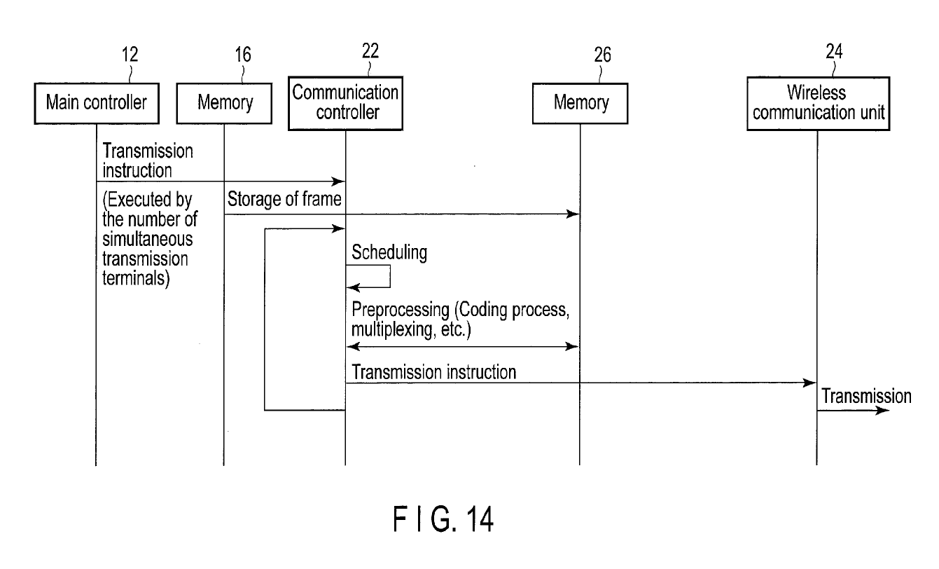

With reference to FIG. 13 and FIG. 14, operation of the wireless communication device 10A of the fifth embodiment is explained. FIG. 13 is a sequence diagram concerning operation of the wireless communication device 10A which receives frames from the wired LAN 8, and transmits them to the wireless LAN. FIG. 14 is a sequence diagram concerning the transmission process of the wireless I/F 20. In the sequence diagrams, it is assumed that the fifth embodiment is the same in structure as the second embodiment illustrated in FIG. 10.

The wireless I/F 20 performs not only a transmission process but also a grouping process in which terminals are classified into groups. When groups have been reconstructed, the wireless I/F 20 transmits group update notification to the main controller 12, as illustrated in FIG. 13. This notification includes group identifiers, identifiers indicative of terminals in each group, and communication rates of the respective terminals (or equivalent information such as a Modulation and Coding Scheme [MCS], for instance). The main controller 12 updates sizes used for simultaneous transmission based on the information. The information is stored in the memory 16. Terminals, which are the objects of simultaneous transmission, and data sizes required for simultaneous transmission are managed in such a manner that the terminals and the data sizes are made to correspond to each other. A plurality of frame sizes may be stored in the memory 16 to comply with various sizes. A plurality of frame sizes may be stored in the memory 16 in association with a certain formula. In any case, the memory 16 stores information for determining a size of a frame needed for each of other terminals in a simultaneous transmission group when a transmission frame is determined for at least one terminal in the simultaneous transmission group.

When the wired I/F 14 receives a frame which should be transferred to the wireless LAN regardless of a sequence of update of simultaneous transmission size information, the received frame is stored in the memory 16 similarly to the first embodiment of FIG. 2. Then, the wired I/F 14 notifies the main controller 12 of receipt of the frame. The main controller 12 subjects the frame in the memory 16 to various processes necessary for transfer.

Then, the main controller 12 refers to the simultaneous transmission size information for every group stored in the memory 16, and specifies the terminals which are objects of simultaneous transmission and transmission frame sizes which are needed for the terminals which are the objects of simultaneous transmission. When the transmission frame size is specified, the main controller 12 reads from the storage 18 frame data having the specified size, stores the frame data in the memory 16, and performs a process (generation of frames, etc.) for transferring them to the wireless network. The main controller 12 determines whether there is another terminal that executes simultaneous transmission. If there is, the same process is repeated two or more times. After the main controller 12 has subjected to a transfer process all the terminals that execute simultaneous transmission, it issues a transmission instruction to the wireless I/F 20.

The wireless I/F 20 receives the transmission instruction in a condition that frames have gathered for each one of the terminals that relate to simultaneous transmission. As illustrated in FIG. 14, the communication controller 22 and the wireless communication unit 24 perform a scheduling process and a preprocess, similarly to FIG. 3. Then, they make every frame have a form suitable for wireless communications, and transmit every frame as a radio wave. The group reconstruction process illustrated in FIG. 3 is independently performed separately from the process of FIG. 14. Therefore, it is not illustrated in FIG. 14.

In the description of FIG. 13, data corresponding to other terminals in the same group are read from the storage 18 upon receipt of a frame which should be transferred from the wired LAN 8 to the wireless LAN. However, it is not necessary to transfer the frame from the wired LAN 8. The transfer process may be started upon reading a frame from the storage 18. However, if there are two or more data transfer destination terminals, it may be difficult to prepare enough data for all the terminals only by using those data that have been read from the storage 18.

There are two solutions for it. A first method accumulates in the memory 16 frames having been received from the wired LAN 8. If data which should be transferred to the terminal 6 are additionally needed, frames will be read out from the memory 16 and will be transferred to the wireless I/F 20, similarly to the case where frames are read from the storage 18. The accumulation size necessary for the memory 16 is dependent on each communication. In a case of a protocol in which information which the wireless communication device 10 can accumulate varies in quantity depending on the presence or absence of ACK, information cannot be accumulated more than a prescription of the protocol. The second method makes a group in such a manner that the number of terminals that require frames received from the wired LAN 8 is restricted to one. As described in the second embodiment, the second method is achievable by giving information on a source as the characteristics information from the main controller 12 when determining a group.

### Summary of Fifth Embodiment

As mentioned above, the fifth embodiment provides a mechanism that the wireless I/F 20 notifies the main controller 12 of information necessary to calculate a size necessary for simultaneous transmission, and the main controller 12 reads from the storage 18 information on specified length and transmits the read information. Read from the storage 18 can be executed smoothly without being affected by the influence of the network, so that indefinite operation does not occur. As a result, useless processes will be eliminated from the communication controller 22. A processing efficiency will be improved. Moreover, a group which performs simultaneous transmission will be restrained from frame shortage, so that improvement in system throughput is expectable.

### Sixth Embodiment

In the fifth embodiment, the wireless I/F 20 determines a simultaneous transmission group and notifies the main controller 12 of information necessary to transmit frames most effectively for the simultaneous transmission group. In the sixth embodiment, when a frame shortage occurs at the time of transmission, the wireless I/F 20 gives the main controller 12 feedback on the frame shortage. Environment will change with movements of terminals etc., so that there is some possibility of communicating with a different method from the time of determining the groups. As a result, even if necessary information is given to the main controller 12 in advance using the method of the fifth embodiment, the excess and deficiency of transmission frames may occur. If a group reconstruction process is performed, the technique of the fifth embodiment may be employed, but if a group reconstruction process is not performed, the method of the present embodiment is used.

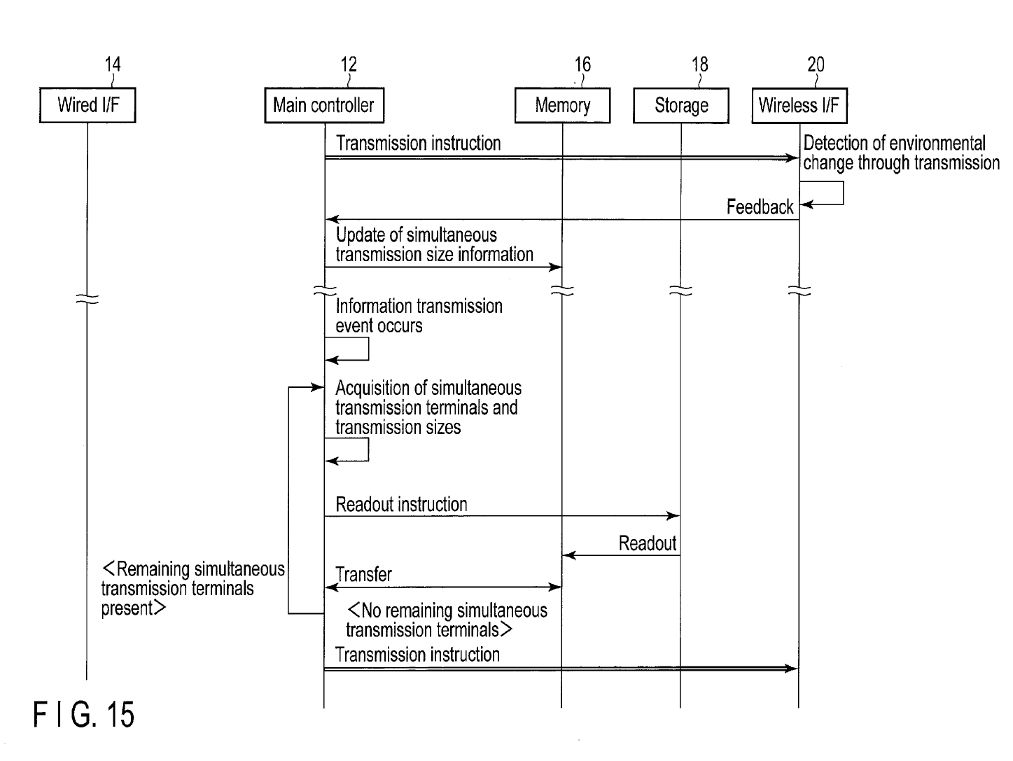

The present embodiment is the same as the second embodiment in block diagram. The operating sequence of the wireless communication device 10A of the sixth embodiment is illustrated in FIG. 15. This sequence indicates the operation after the main controller 12 has issued a transmission instruction to the wireless I/F 20. Although the wireless I/F 20 transmits the instructed information, if it executes different transmission from the time when groups were determined, for example, if it executes transmission different in transmitting rate, it gives the main controller 12 feedback on the different transmission. This feedback includes an identifier of the objective terminal and the changed transmitting rate. In response, the main controller 12 updates the simultaneously transmitting size information stored in the memory 16. Henceforth, an efficient transmitting process can be maintained by performing the same process as the fifth embodiment using the updated size information.

In the example of FIG. 15, it is assumed that an event that the storage 18 transmits data has occurred. For example, a case where a contents transmission program executes transmission in response to an acquisition request is equivalent to this example. The main controller 12 acquires the existence of a terminal which executes transmission simultaneously with a terminal which transmission has been notified in an event, and the size of updated information in response to the feedback. The main controller 12 reads data using the size of updated information, executes a transfer process, and transmits a transmission instruction to the wireless I/F 20.

### Summary of Sixth Embodiment

As mentioned above, when the wireless I/F 20 detects change in a communication rate, the wireless I/F 20 notifies the main controller 12 of the detected change, and thus a transmitting process in a suitable size can be continued in the sixth embodiment.

### Seventh Embodiment

In the fifth and sixth embodiment, the wireless I/F 20 notifies the main controller 12 of information, including the communication rate for calculating a simultaneous transmission size, etc. When simultaneous transmission occurs, it is unknown which data headed for which terminal runs short in what amount until a transmission process is executed. Therefore, the wireless I/F 20 provides information for calculating a simultaneous transmission size. Based on the information, the main controller 12 calculates a simultaneous transmission size required for simultaneously transmitting data addressed to a plurality of terminals and occupying the same time.

The seventh embodiment is a modification of the fifth or the sixth embodiment. In the two former embodiments, the main controller 12 receives notification from the wireless I/F 20, changes data size necessary for executing transmission after the notification, and goes on with transmission process. In the seventh embodiment, the wireless I/F 20 suspends the transmission process upon detection of transmission data shortage, and notifies the main controller 12 of that effect. When the notification is information of data shortage, the main controller 12 immediately supplies to the wireless I/F 20 data of the size which runs short based on the notification.

The seventh embodiment is the same in block diagram as the first or the second embodiment. When the seventh embodiment is structurally the same as the second embodiment, the data running short is read from the storage 18. When the seventh embodiment is structurally the same as the first embodiment, the data running short is read from the memory 16.

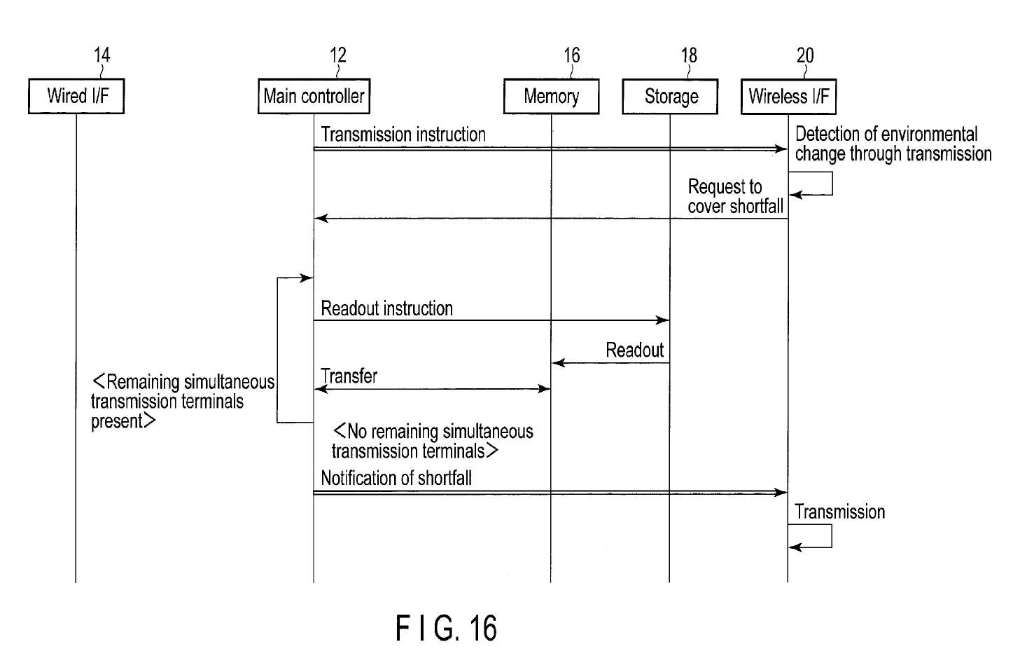

FIG. 16 is a sequence diagram of the seventh embodiment in the case of using the block diagram of the second embodiment. The wireless I/F 20 executes a transmission process in accordance with the transmission instruction from the main controller 12. The wireless I/F 20 recognizes that wireless environment has changed and there is a terminal which has a space occupying time different from the original space occupying time. Therefore, the wireless I/F 20 requests the main controller 12 to supply data of a size which is running short because of change in space occupancy time. The main controller 12 reads the requested data for the terminals from the memory 16 or the storage 18, performs a transmission process, and notifies the wireless I/F 20 of that effect. The wireless I/F 20 changes data into a state where it can perform simultaneous transmission including the added data, and executes simultaneous transmission to the terminal 6.

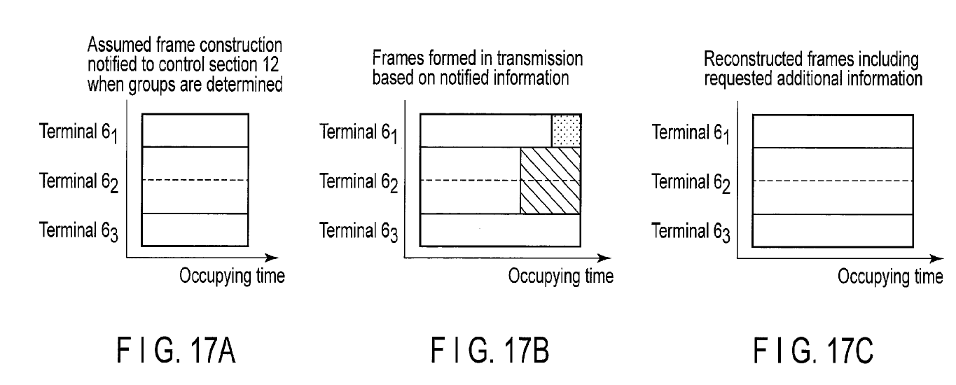

FIGS. 17A, 17B, and 17C schematically illustrate how wireless transmission frames which are simultaneously transmitted in the above process are constructed. Let us suppose that terminals 6₁, 6₂, and 6₃ constitute a group at the beginning, are determined to have the same simultaneous transmission size, and are allowed to execute transmission for the same space occupying time, as illustrated in FIG. 17A, but that the radio wave state has changed, because of which the terminals 6₁ and 6₃ require much longer time to transmit data having a certain size, of which the main controller 12 has been notified. Let us suppose further that the terminal 6₃ now requires much longer time than the terminal 6₁. Therefore, it may happen that the size by means of which the main controller 12 requests transmission is short by the respective portions (slanted line portions) for the terminals 6₁ and 6₂, as illustrated in FIG. 17B. The communication controller 22 which has recognized this notifies the main controller 12 of a lacking size, and requests transmission of lacking data. In the case of FIG. 17B, a portion which the terminal 6₁ lacks and a portion which the terminal 6₂ lacks are requested. If additional data can be acquired for the respective two terminals, a simultaneous transmission frame is eventually reconstructed, as illustrated in FIG. 17C. If data which make up for the respective lacking portions for the terminals 6₁ and 6₂ cannot be acquired, redundant data, including delimiters etc., are padded to make the frames in uniform space occupying time, and then the uniformly arranged frames are transmitted.

### Summary of Seventh Embodiment

When a plurality of wireless frames are simultaneously transmitted to a plurality of terminals, the plurality of wireless frames may become irregular in space occupying time, and thus a wireless frame which is shorter in space occupying time than the wireless frames transmitted to other terminals in a group may occur, resulting in an occurrence of terminals which run short of data to transmit. As mentioned above, the wireless I/F 20 in the seventh embodiment requests the main controller 12 to transmit data which fills the lacking portion. The main controller 12 reads data from the memory 16 or the storage 18, and supplies the read data to the wireless I/F 20. This makes it possible to continue transmitting process using a particular simultaneous transmission size fixed at the beginning even if a communication rate changes. The communication controller 22 therefore can much surely perform simultaneous transmission. Moreover, the size of the memory 26 used as a queue can be made small.

Since the processing of the embodiments can be implemented by the computer program, advantages similar to the advantages of the embodiments can easily be obtained by installing the computer program in a computer via a computer-readable storage medium in which the computer program is stored and by merely executing the computer program.

While certain embodiments have been described, these embodiments have been presented by way of example only, and are not intended to limit the scope of the inventions. Various inventions can be made by proper combinations of constituent elements disclosed in the above embodiments. For example, some constituent elements may be deleted from the constituent elements disclosed in the embodiments. Constituent elements of different embodiments may be used in proper combinations.

What is claimed is:

1. A wireless communication device comprising:
a wireless communication unit connected to a wireless network; and
a controller configured to control the wireless communication unit, wherein
the controller is configured to notify the wireless communication unit of characteristics information on communications of the wireless network, and
the wireless communication unit is configured to simultaneously transmit signals to the wireless network based on the characteristics information.

2. The wireless communication device of claim 1, wherein the characteristics information comprises an index characterizing transmission and reception between the wireless communication unit and first terminals connected to the wireless network.

3. The wireless communication device of claim 2, wherein the wireless communication unit is configured to simultaneously transmit the signals to a group of terminals which is selected from the first terminals based on the characteristics information.

4. The wireless communication device of claim 1, wherein the characteristics information is indicative of a size of each of the signals to be simultaneously transmitted from the wireless communication unit to the wireless network and information necessary for calculating the size.

5. The wireless communication device of claim 4, wherein the size is configured to make equal in transmitting time the signals simultaneously transmitted from the wireless communication unit to the wireless network.

6. The wireless communication device of claim 1, wherein the characteristics information is indicative of at least one of a throughput and a frame interval of the communications.

7. The wireless communication device of claim 1, further comprising:
a receiver configured to receive data from a wired network, and
a memory configured to store data to be transmitted to a terminal connected to the wireless network, wherein
the characteristics information further indicates whether the signals to be transmitted to the wireless network comprise data stored in the memory or data received from the wired network by the receiver.

8. The wireless communication device of claim 1, wherein the wireless communication unit is configured to classify terminals into groups of terminals, based on the characteristics information, and determine a sequence of transmission to the groups of terminals based on the characteristics information.

9. The wireless communication device of claim 8, wherein the wireless communication unit is configured to notify the controller of a size of each of the signals to be simultaneously transmitted to a group of terminals or of information necessary for calculating the size.

10. The wireless communication device of claim 9, wherein the controller is configured to cause the wireless communication unit to transmit at a next time wireless communication the size notified from the wireless communication unit or a size obtained by calculation executed based on the information notified from the wireless communication unit.

11. The wireless communication device of claim 10, wherein the controller is configured to supply to the wireless communication unit a signal causing additional transmission to be performed based on the size notified from the wireless communication unit, and reconstruct signals to be simultaneously transmitted to the wireless network based on the signal causing additional transmission to be performed.

12. A wireless communication method of a wireless communication device comprising a wireless communication unit connected to a wireless network, the method comprising:
notifying the wireless communication unit of characteristics information on each communication of the wireless network; and
simultaneously transmitting a plurality of signals to the wireless network based on the characteristics information.

13. A non-transitory computer-readable storage medium having stored thereon a computer program which is executable by a computer comprising a wireless communication unit connected to a wireless network, the computer program comprising instructions capable of causing the computer to execute functions of:
a wireless communication unit connected to a wireless network; and
notifying the wireless communication unit of characteristics information on each communication of the wireless network; and
simultaneously transmitting a plurality of signals to the wireless network based on the characteristics information.
